(19) United States
(12) Patent Application Publication
(10) Pub. No.: US 2018/0248437 A1
(43) Pub. Date: Aug. 30, 2018

(54) MOTOR AND SPINNING MACHINE

(71) Applicant: Nidec Corporation, Kyoto (JP)

(72) Inventors: Akira SAKAUCHI, Kyoto (JP); Takeru KUWAHARA, Kyoto (JP); Mitsuyuki MIYAUCHI, Kyoto (JP)

(21) Appl. No.: 15/754,326

(22) PCT Filed: Aug. 17, 2016
(86) PCT No.: PCT/JP2016/074031

§ 371 Date: Feb. 22, 2018

(30) Foreign Application Priority Data
Sep. 28, 2015 (JP) 2015-189437

(51) Int. Cl. H02K 3/50; H02K 1/16; H02K 1/27; H02K 5/06; H02K 5/10; H02K 5/22; H02K 7/08; H02K 11/21; D01H 1/24

(52) U.S. Cl. CPC H02K 3/50; H02K 1/16; H02K 1/2786; H02K 5/06; H02K 5/10; H02K 2211/03; H02K 7/088; H02K 11/21; D01H 1/24; H02K 2203/03; H02K 2203/06; H02K 5/225

(57) ABSTRACT

A motor includes a stationary portion that includes a shaft extending vertically along a central axis, a rotating portion that rotates around the central axis as a center, and a bearing that rotatably supports the rotating portion with respect to the shaft. The rotating portion includes on an outer side of the stationary portion in a radial direction a cylindrical motor casing that extends in an axial direction around the shaft as a center and a magnet that is disposed on an inner peripheral surface of the motor casing. The stationary portion includes a circuit board that is perpendicularly disposed with respect to the shaft, and a stator that is positioned below the circuit board in the axial direction and above the bearing in the axial direction. The stator includes a stator core that includes a ring-shaped core back having the central axis as the center and a plurality of teeth extending outward from the core back in the radial direction, and a coil that includes a conductor wire wound around the teeth. A first conductor wire that is led out from the coil is connected to the circuit board. A second conductor wire is connected to an upper surface of the circuit board in the axial direction.

### BACKGROUND OF THE INVENTION

### 1. Field of the Invention

The present invention relates to a motor and a spinning machine.

### 2. Description of the Related Art

Hitherto, a motor of a so-called outer rotor type in which a rotating portion is disposed on an outer side of a stator, which is a stationary portion, has been known. A motor of the outer rotor type (simply referred to as “motor” below) is used in, for example, industrial machines such as spinning machines that take up thread. An existing motor is described in, for example, U.S. Pat. No. 7,049,718. In the motor described in this publication, bearings are disposed on an inner side of a cylindrical portion, which is a rotating portion, in a radial direction. The bearings rotatably support the cylindrical portion, which is a rotating portion, with respect to a shaft that is fixed with a central axis as a center. The bearings are disposed both above and below a stator in a central axis direction.

In the motor that is described in U.S. Pat. No. 7,049,718, the bearings contact both the shaft and the cylindrical portion on both sides of the stator. Therefore, in order to lead out from a side of the stator a conductor wire for connection to the outside of the motor, it is necessary to perform processing operations, such as shaving of the shaft. In addition, it is necessary to provide a passage for leading out the conductor wire to the outside. Such processing operations cost considerably and require time. Therefore, if such processing operations can be omitted, it is possible to reduce manufacturing costs of the motor.

### SUMMARY OF THE INVENTION

It is an object of the present invention to provide a motor that allows a conductor wire to be led out from a stator without performing complicated processing operations on a shaft.

An exemplary embodiment of the invention of the present application provides a motor of an outer rotor type. The motor includes a stationary portion that includes a shaft extending vertically along a central axis; a rotating portion that rotates around the central axis as a center; and at least one bearing that supports the rotating portion with respect to the shaft so as to be rotatable around the central axis as the center. The rotating portion includes on an outer side of the stationary portion in a radial direction a cylindrical motor casing that extends in an axial direction around the shaft as a center and a magnet that is disposed on an inner peripheral surface of the motor casing. The stationary portion includes a circuit board that is perpendicularly disposed with respect to the shaft, and a stator that is positioned below the circuit board in the axial direction and above the bearing in the axial direction. The stator includes a stator core that includes a ring-shaped core back having the central axis as the center and a plurality of teeth extending outward from the core back in the radial direction, and a coil that includes a conductor wire wound around the teeth. A first conductor wire that is led out from the coil is connected to the circuit board, and a second conductor wire is connected to an upper surface of the circuit board in the axial direction.

According to an exemplary embodiment of the invention of the present application, it is possible to lead out a conductor wire in a direction opposite to the bearing. Therefore, it is not necessary to perform complicated processing operations on the shaft. Consequently, it is possible to reduce manufacturing costs of the motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 illustrates a structure of a spinning machine including a motor according to a first embodiment of the present invention.

FIG. 2 is a vertical sectional view of the motor according to the first embodiment.

FIG. 3 is a top view of the motor according to the first embodiment.

FIG. 4 is a partial sectional view of the motor according to the first embodiment.

FIG. 5 is an enlarged sectional view of the motor according to the first embodiment.

FIG. 6 is an enlarged sectional view of a motor according to a modification.

### DETAILED DESCRIPTION OF THE PREFERRED EMBODIMENTS

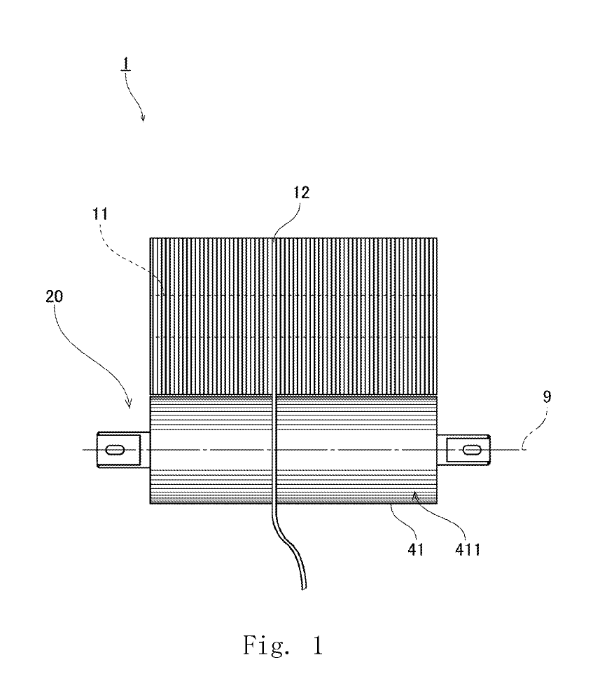

An exemplary motor and an exemplary spinning machine are disclosed below. In this disclosure, the right side and the left side in FIG. 1 in a central axis direction of the motor are described as an “upper side” and a “lower side”, respectively. A direction parallel to the central axis is simply described as an “axial direction”; a radial direction having the central axis as a center is simply described as a “radial direction”; and a peripheral direction having the central axis as the center is simply described as a “peripheral direction”. However, such definitions of these directions are not intended to limit the directions at the time of manufacture and use of the motor and the spinning machine.

FIG. 1 illustrates a structure of a spinning machine 1 including a motor 20 according to a first embodiment. The spinning machine 1 is a machine for winding a thread 12 around a bobbin 11. The motor 20 rotates a vertically extending cylindrical motor casing 41 around a central axis 9 as a center. The bobbin 11 is a rod-shaped member that contacts an outer peripheral surface of the motor casing 41 and that is disposed parallel to the central axis 9. The bobbin 11 rotates in response to the movement of the motor casing 41 and in a direction opposite to that of the motor casing 41.

The thread 12 is supplied from a thread supplying portion (not shown), and an end thereof is fixed to the bobbin 11. When the bobbin 11 rotates due to the rotation of the motor casing 41, the thread 12 is successively fed from the thread supplying portion and is wound around the bobbin 11. Then, the motor casing 41 further rotates in contact with the thread 12 wound around the bobbin 11. The bobbin 11 further takes up the thread 12 while the bobbin 11 is pushed and moved outward in the radial direction from the motor casing 41 as the thickness of the wound thread 12 increases. This causes the bobbin 11 around which the thread 12 is wound to be manufactured. That is, the bobbin 11 rotates in response to the movement of the motor 20, and takes up the thread 12. This structure makes it possible to reduce manufacturing costs of the spinning machine 1. The spinning machine 1 can also be reduced in size.

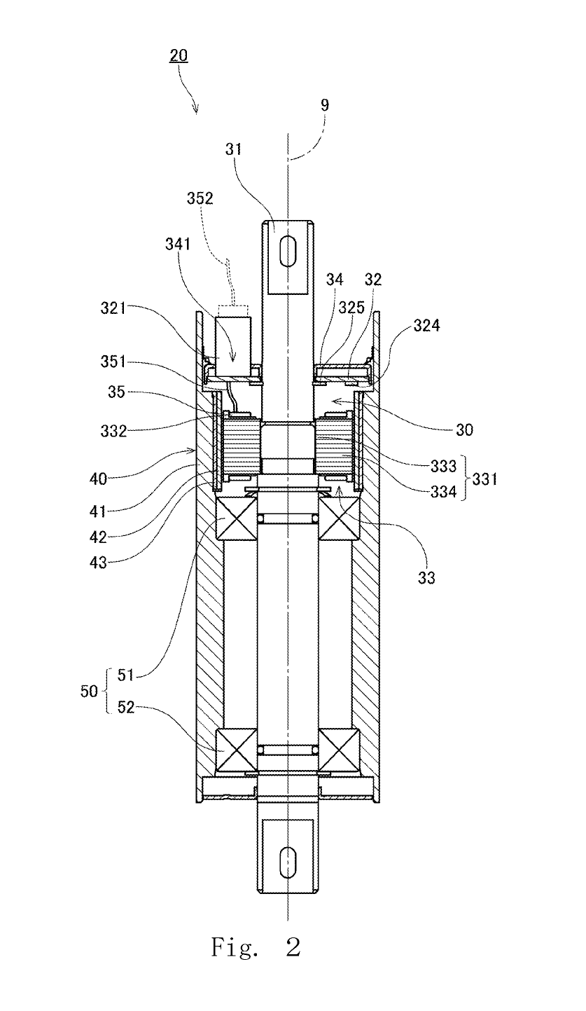

Next, a detailed structure of the motor 20 that is used in the spinning machine 1 is described. FIG. 2 is a vertical sectional view of the motor 20 according to the first embodiment. In the motor 20, a magnet 42 is disposed on an outer side of a stator 33 in the radial direction. That is, the motor 20 is a motor of an outer rotor type. The motor 20 includes a stationary portion 30, a rotating portion 40, and a bearing 50.

The stationary portion 30 is stationary relative to a frame body of the spinning machine 1. The stationary portion 30 includes a shaft 31, a circuit board 32, the stator 33, and a plate 34.

The shaft 31 is a substantially circular columnar member extending vertically in the axial direction along the central axis 9. That is, the stationary portion 30 includes the shaft 31 extending vertically along the central axis 9. The shaft 31 is made of, for example, a metal, such as stainless steel or carbon steel. An upper end portion of the shaft 31 protrudes above the motor casing 41 in the axial direction. A lower end portion of the shaft 31 protrudes below the motor casing 41 in the axial direction. The upper end portion and the lower end portion of the shaft 31 are each fixed to the frame body of the spinning machine 1.

The stator 33 is a portion that generates magnetic flux in accordance with driving current. The stator 33 is positioned below the circuit board 32 in the axial direction and above the bearing 50 in the axial direction. The stator 33 includes a stator core 331 and a coil 332. The stator core 331 is a laminated steel plate including a plurality of steel plates that are laminated in the axial direction. The stator core 331 includes a ring-shaped core back 333 having the central axis 9 as the center and a plurality of teeth 334 extending outward from the core back 333 in the radial direction. The coil 332 includes a conductor wire 35 wound around the teeth 334. An end portion of the conductor wire 35 is led out as a first conductor wire 351 from the coil 332 towards the circuit board 32. That is, the first conductor wire 351 that is led out from the coil 332 is connected to the circuit board 32.

The circuit board 32 is a substantially plate-shaped member on which electronic circuits and electronic components are mounted. Above the stator 33 and inwardly of the motor casing 41 in the radial direction, the circuit board 32 is disposed perpendicularly to the shaft 31. That is, the stationary portion 30 includes the circuit board 32 that is disposed perpendicularly to the shaft 31. However, the circuit board 32 may be substantially perpendicular to the shaft 31. In the embodiment, the circuit board 32 is disposed in contact with a supporting portion 325 fixed perpendicularly to the shaft 31. This positions the circuit board 32 inside the motor casing 41.

The circuit board 32 is connected to the first conductor wire 351 that is led out from the coil 332. A second conductor wire 352 is connected to an upper surface of the circuit board 32 in the axial direction. Electric current supplied from an external power source flows to the coil 332 via the second conductor wire 352, the circuit board 32, and the first conductor wire 351. Although, in the example shown in FIG. 1, the number of first conductor wires 351 that is led out from the coil 332 is one, a plurality of first conductor wires 351 may be led out from the coil 332. The plurality of first conductor wires 351 may be connected to the circuit board 32.

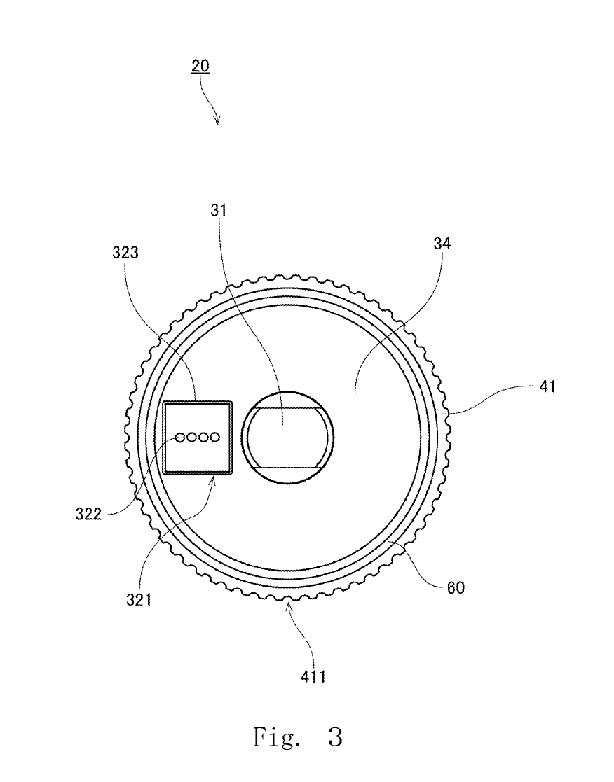

FIG. 3 is a top view of the motor 20. In the embodiment, a connector 321 is positioned at the upper surface of the circuit board 32. The connector 321 includes a terminal 322 that is connected to the second conductor wire 352 and a cover portion 323 that surrounds an outer periphery of the terminal 322. The terminal 322 is made of a metal, which is a conductor, and is electrically connected to the first conductor wire 351 led out from the coil 332. The second conductor wire 352 extending to the outside of the motor 20 is connected to the terminal 322. This makes it possible to easily connect the second conductor wire 352 and the circuit board 32 to each other. Since a connection portion where the first conductor wire 351 and the second conductor wire 352 are connected is sealed, a hot mold step is not required. Therefore, it is possible to prevent the conductor wire 35 from becoming damaged due to the hot mold step.

The cover portion 323 is made of a resin, which is an insulating material, and surrounds the outer periphery of the terminal 322 in the shape of a ring. This makes it possible to prevent the terminal 322 from contacting impurities, such as water and dust. The motor 20 of the embodiment is particularly used in the spinning machine 1. Accordingly, the motor 20 is used in an environment in which foreign substances, such as waste thread, tend to be produced. However, the cover portion 323 makes it possible to prevent contact of the terminal 322 with foreign substances, such as waste thread. Therefore, it is possible to suppress deterioration, such as corrosion, of the terminal 322, and to increase the life of the motor 20.

The plate 34 is a substantially plate-shaped member that extends perpendicularly to the central axis 9. The plate 34 may extend substantially perpendicularly to the central axis 9. The plate 34 is disposed inwardly of the motor casing 41 in the radial direction and extends perpendicularly to the central axis 9 at a location above the circuit board 32 in the axial direction and below an upper end of the motor casing 41 in the axial direction. The plate 34 blocks a portion between the motor casing 41 and the shaft 31. This makes it possible to prevent entry of foreign substances into the motor 20 from the outside. In the embodiment, a plate 34 is also disposed below the bearing 50. This makes it possible to further prevent entry of foreign substances into the motor 20. The plate 34 has a through hole 341. The connector 321 is disposed in the through hole 341. This allows a plurality of second conductor wires 352 to be connected by the connector 321.

The rotating portion 40 is a portion that rotates around the central axis 9 as the center. The rotating portion 40 includes the motor casing 41, the magnet 42, and a rotor yoke 43.

The motor casing 41 accommodates the stationary portion 30 and the bearing 50 therein. The motor casing 41 is a cylindrical member extending in the axial direction around the shaft 31 as a center on an outer side of the stationary portion 30 in the radial direction. As shown in FIGS. 1 and 3, a plurality of groove portions 411 extending in the axial direction are provided on an outer peripheral portion of the motor casing 41. Therefore, friction between the motor casing 41 and the bobbin 11 is increased. Consequently, when the motor casing 41 rotates, the bobbin 11 rotates easily without rotating idly. In addition, friction between the motor casing 41 and the thread 12 is increased. Therefore, when the motor casing 41 rotates, the thread 12 is easily fed to the bobbin 11.

It is desirable that the motor casing 41 be made of an aluminum alloy. Compared to other metal materials, such as iron, aluminum alloy has low hardness and a low melting point. Therefore, it becomes easier to form the groove portions 411 on the outer peripheral portion of the motor casing 41 and to process an inner peripheral portion thereof by cutting. In addition, it is possible to easily form the groove portions 411 on the outer peripheral portion of the motor casing 41 by extrusion. Therefore, it is possible to reduce manufacturing costs of the motor 20. By using aluminum alloy, it is possible to reduce the weight of the motor casing 41. Therefore, it is possible to reduce power consumption for driving the motor 20. In addition, it is possible to reduce vibration and noise generated by driving the motor 20. However, the motor casing 41 may be made of materials other than aluminum alloy.

Referring back to FIG. 2, the magnet 42 is disposed directly on an inner peripheral surface of the motor casing 41 or is disposed on the inner peripheral surface of the motor casing 41 with the rotor yoke 43 interposed therebetween. The rotor yoke 43 is a circular-ring-shaped member made of a magnetic material. For example, the rotor yoke 43 is fixed by being press-fitted to the inner peripheral surface of the motor casing 41. However, the rotor yoke 43 may be fixed to the inner peripheral surface of the motor casing 41 by other methods, such as press-fit adhesion.

The magnet 42 may be one circular-ring-shaped member alternately magnetized at an N pole and an S pole in the peripheral direction. The magnet 42 is fixed to an inner peripheral surface of the rotor yoke 43 with, for example, an adhesive. An inner peripheral surface of the magnet 42 faces in the radial direction outer end surfaces of the plurality of teeth 334 in the radial direction. An inner surface of the magnet 42 in the radial direction is a magnetic pole surface facing the stator 33. Instead of using the one circular-ring-shaped magnet 42, a plurality of magnets that are arranged in the peripheral direction such that N poles and S poles are alternately arranged may be used. The magnet 42 may be, for example, an Nd—Fe—B-alloy-based sintered magnet.

When the motor casing 41 is made of a magnetic material, such as iron, the rotor yoke 43 may be omitted. In this case, the magnet 42 is directly fixed to the inner peripheral surface of the motor casing 41.

The motor 20 includes one or more bearings 50. The bearing 50 supports the rotating portion 40 with respect to the shaft 31 so as to be rotatable around the central axis 9 as the center. The bearing 50 is disposed below the stator 33. In the embodiment, the bearing 50 includes an upper bearing 51 and a lower bearing 52 that is disposed below the upper bearing 51. The upper bearing 51 and the lower bearing 52 of the embodiment are each ball bearings in which an outer ring and an inner ring are rotated relative to each other via a ball. The inner ring of the upper bearing 51 and the inner ring of the lower bearing 52 are fixed to an outer peripheral surface of the shaft 31. The outer ring of the upper bearing 51 and the outer ring of the lower bearing 52 are fixed to the inner peripheral surface of the motor casing 41. Instead of using ball bearings, other types of bearings, such as sliding bearings or fluid bearings, may be used for the bearing 50.

In such a motor 20, when driving current is applied to the coil 332 of the stator 33, magnetic flux in the radial direction is generated at the plurality of teeth 334 of the stator core 331. By the action of the magnetic flux between the teeth 334 and the magnet 42, a torque in the peripheral direction is generated. As a result, the rotating portion 40 rotates with respect to the stationary portion 30 around the central axis 9 as the center. When the rotating portion 40 rotates, the bobbin 11 also rotates along with the motor casing 41.

Accordingly, in the motor 20 of the embodiment, the bearing 50 is disposed only below the stator 33 in the axial direction. In addition, the first conductor wire 351 is led out from the coil 332 of the stator 33 in a direction opposite to the bearing 50. Therefore, it is not necessary to perform complicated processing operations on the shaft 31 in order to lead out the conductor wire so as to avoid the bearing 50. Consequently, it is possible to reduce manufacturing costs of the motor 20.

Next, a sensor 324 and a dust seal 60 are described.

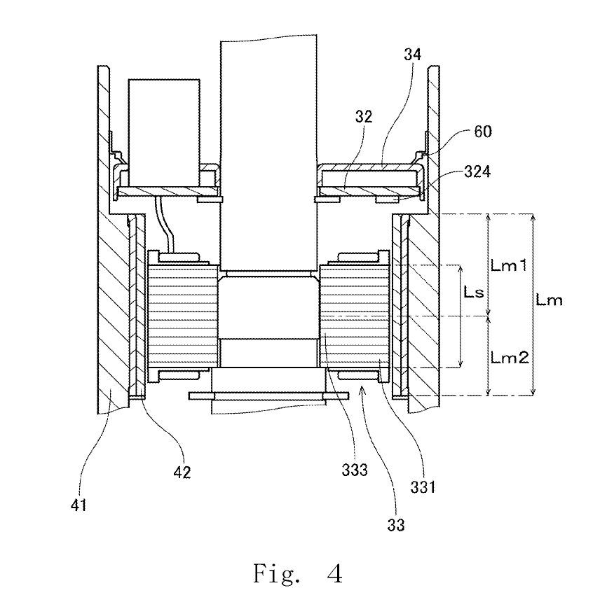

FIG. 4 is a partial sectional view of the vicinity of the stator 33 of the motor 20. In the embodiment, the circuit board 32 is provided with at least one sensor 324 on a lower surface thereof in the axial direction. The sensor 324 detects magnetic flux of the magnet 42. This makes it possible to detect the rotation speed of the motor casing 41. The rotation speed of the motor casing 41 is subjected to feedback control on the basis of the results of detection by the sensor 324. The number of sensors 324 to be mounted on the circuit board 32 may be one or two or more. When a plurality of sensors 324 are provided, it is possible to precisely detect the magnetic flux of the magnet 42.

As shown in FIG. 4, a length of the core back 333 in the axial direction is Ls. A length in the axial direction from the center of the stator core 331 in the axial direction to an upper end portion of the magnet 42 in the axial direction is Lm1. Here, Ls and Lm1 satisfy the relationship Lm1>Ls. That is, the length Ls of the core back 333 in the axial direction and the length Lm1 in the axial direction from the center of the stator core 331 in the axial direction to the upper end portion of the magnet 42 in the axial direction satisfy the relationship Lm1>Ls. Therefore, it is possible to bring the upper end portion of the magnet 42 close to the sensor 324. Further, since the distance between the core back 333 and the sensor 324 in the axial direction can be made large, magnetic flux that is generated near the coil 332 at the core back 333 does not easily influence the sensor 324. Therefore, it is possible to increase the precision with which the magnetic flux of the magnet 42 is detected by the sensor 324.

A length in the axial direction from a lower end portion of the magnet 42 in the axial direction to the center of the stator core 331 is Lm2. Here, Lm1 and Lm2 satisfy the relationship Lm1>Lm2. That is, Lm1 and the length Lm2 in the axial direction from the lower end portion of the magnet 42 in the axial direction to the center of the stator core 331 satisfy the relationship Lm1>Lm2. Therefore, it is possible to bring the upper end portion of the magnet 42 close to the sensor 324 while reducing the length Lm of the entire magnet 42 in the axial direction.

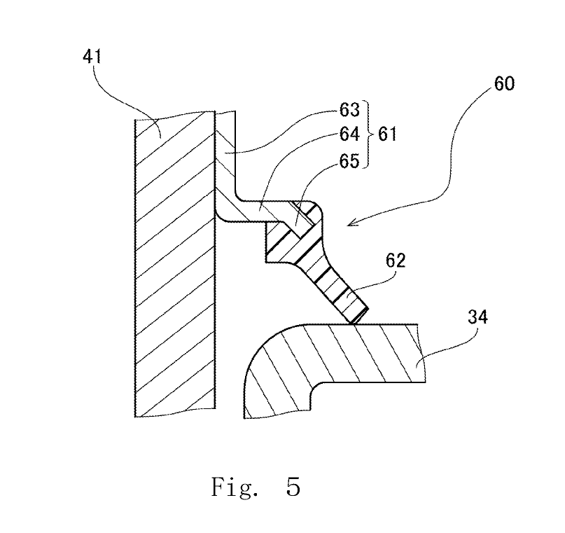

In the embodiment, the rotating portion 40 further includes the dust seal 60. FIG. 5 is an enlarged sectional view of the vicinity of the dust seal 60 of the motor 20. The dust seal 60 is a circular-ring-shaped member, and is fitted and fixed to the inner peripheral surface of the motor casing 41. Part of the dust seal 60 contacts the plate 34. That is, the dust seal 60 blocks a portion between the plate 34 and the motor casing 41. Therefore, it is possible to prevent entry of impurities, such as water and dust, into the motor 20.

In the embodiment, the dust seal 60 is a two-color molded part including a metal portion 61 that is made of a metal and a resin portion 62 that is made of a resin. When manufacturing the dust seal 60, the resin portion 62 is molded by pouring a resin into a mold with the metal portion 61 previously disposed in the inside of the mold. The metal portion 61 includes a cylindrical portion 63 that extends in the axial direction along the inner peripheral surface of the motor casing 41, a ring-shaped flat-plate portion 64 that protrudes inward from the cylindrical portion 63 in the radial direction, and an inclined portion 65 that is bent inward in the radial direction and downward in the axial direction from the flat-plate portion 64. The resin portion 62 is disposed at an inner end portion of the inclined portion 65 in the radial direction. In addition, the resin portion 62 contacts the plate 34. Accordingly, when the elastic resin portion 62 contacts the plate 34, it is possible to increase waterproofness and dust resistance by using the dust seal 60. In addition, the dust seal 60 is easily incorporated in the motor casing 41.

In the embodiment, the metal portion 61 is fixed to the inner peripheral surface of the motor casing 41. Therefore, it is possible to increase the fixing strength of the dust seal 60 with respect to the motor casing 41. In addition, the dust seal 60 can be easily incorporated in the motor casing 41.

Although an exemplary embodiment of the present invention is described above, the present invention is not limited to the above-described embodiment.

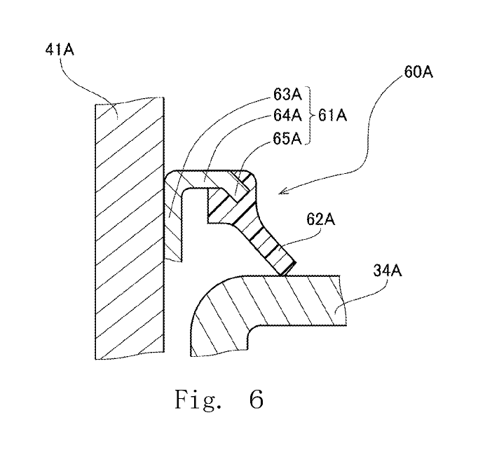

FIG. 6 is an enlarged sectional view of the vicinity of a dust seal 60A of a motor according to a modification. A metal portion 61A of the dust seal 60A includes a cylindrical portion 63A that extends in the axial direction along an inner peripheral surface of a motor casing 41A, a ring-shaped flat-plate portion 64A that protrudes inward from an upper end of the cylindrical portion 63A in the radial direction, and an inclined portion 65A that is bent inward in the radial direction and downward from an inner end of the flat-plate portion 64A. The resin portion 62A is disposed at an inner end portion of the inclined portion 65A in the radial direction. In addition, the resin portion 62A contacts a plate 34A. Even if such a structure is used, the dust seal 60A is capable of blocking a portion between the motor casing 41A and the plate 34A. Therefore, the dust seal 60A is easily incorporated in the motor casing 41A.

In the above-described embodiment, the circuit board is a member on which electronic circuits and electronic components are mounted. However, the circuit board may be a member having electrical conductivity, or a wiring board that supports a conductor wire. In this case, the conductor wire is routed on the wiring board, is directly connected to a terminal pin, and driving current is supplied.

In the above-described embodiment, the bearing includes two bearings, an upper bearing and a lower bearing. However, the number of bearings may be one or three or more.

In the above-described embodiment, the motor is used in a spinning machine. However, the motor may be used in other applications.

The shapes of specific portions of the members may differ from the shapes illustrated in each figure of the present application. Each element appearing in the above-described embodiment and modification may be combined as appropriate within a scope that is not contradictory.

The present invention is applicable to a motor and a spinning machine.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-11. (canceled)

12: A motor of an outer rotor type, comprising:
a stationary portion that includes a shaft extending vertically along a central axis;
a rotating portion that rotates around the central axis as a center; and
at least one bearing that supports the rotating portion with respect to the shaft so as to be rotatable around the central axis as the center,
wherein the rotating portion includes on an outer side of the stationary portion in a radial direction
a cylindrical motor casing that extends in an axial direction around the shaft as a center, and
a magnet that is disposed directly on an inner peripheral surface of the motor casing or that is disposed on the inner peripheral surface of the motor casing with a rotor yoke interposed therebetween,
wherein the stationary portion includes
a circuit board that is perpendicularly disposed with respect to the shaft, and
a stator that is positioned below the circuit board in the axial direction and above the bearing in the axial direction, and
wherein the stator includes
a stator core that includes a ring-shaped core back having the central axis as the center and a plurality of teeth extending outward from the core back in the radial direction, and
a coil that includes a conductor wire wound around the teeth,
wherein a first conductor wire that is led out from the coil is connected to the circuit board, and
wherein a second conductor wire is connected to an upper surface of the circuit board in the axial direction.

13: The motor according to claim 12,
wherein a plurality of the second conductor wires are connected by a connector, and
wherein the connector is positioned at the upper surface of the circuit board.

14: The motor according to claim 13,
wherein the connector includes
a terminal that is connected to the plurality of the second conductor wires, and
a cover portion that surrounds an outer periphery of the terminal.

15: The motor according to claim 12, further comprising:
a plate that is disposed inwardly of the motor casing in the radial direction and that extends perpendicularly to the central axis at a location above the circuit board in the axial direction and below an upper end of the motor casing in the axial direction, and
a dust seal that blocks a portion between the plate and the motor casing.

16: The motor according to claim 15,
wherein the dust seal is a two-color molded part and includes
a metal portion that is made of a metal, and
a resin portion that is made of a resin, and
wherein the metal portion is fixed to the inner peripheral surface of the motor casing, and
wherein the resin portion contacts the plate.

17: The motor according to claim 16,
wherein metal portion includes
a cylindrical portion that extends in the axial direction along the inner peripheral surface of the motor casing,
a ring-shaped flat-plate portion that protrudes inward from the cylindrical portion in the radial direction, and
an inclined portion that is bent inward in the radial direction and downward in the axial direction from the flat-plate portion, and
wherein the resin portion is disposed at an inner end portion of the inclined portion in the radial direction.

18: The motor according to claim 12,
wherein the circuit board is provided with at least one sensor on a lower surface thereof in the axial direction, and
wherein the sensor detects magnetic flux of the magnet.

19: The motor according to claim 18,
wherein a length Ls of the core back in the axial direction and a length Lm1 in the axial direction from a center of the stator core in the axial direction to an upper end portion of the magnet in the axial direction satisfy a relationship Lm1>Ls.

20: The motor according to claim 19,
wherein the Lm1 and a length Lm2 in the axial direction from a lower end portion of the magnet in the axial direction to the center of the stator core satisfy a relationship Lm1≥Lm2.

21: The motor according to claim 12, wherein the motor casing is made of an aluminum alloy.

22: A spinning machine comprising:
the motor according to claim 12, and
a bobbin that rotates in response to movement of the motor and that takes up thread.
